(19) United States
(12) Patent Application Publication
(10) Pub. No.: US 2024/0271474 A1
(43) Pub. Date: Aug. 15, 2024

(54) Actuation Mechanism for Actuating a Cover or Flap of a Vehicle

(71) Applicant: Illinois Tool Works Inc., Glenview, IL (US)

(72) Inventors: Roland OCH, Rottendorf (DE); Matthias HEGWEIN, Ippesheim (DE); Lubomír KOZEL, Rožnov pod Radhoštem (CZ)

(21) Appl. No.: 18/409,464

(22) Filed: Jan. 10, 2024

(30) Foreign Application Priority Data
Feb. 14, 2023 (DE) 10 2023 103 576.2

(51) Int. Cl. E05F 1/12; B60J 10/86; E05F 15/63

(52) U.S. Cl. CPC E05F 1/1253; B60J 10/86; E05F 15/63; E05Y 2201/638; E05Y 2900/534

(57) ABSTRACT

Disclosure is an actuating mechanism (1) for actuating a cover or flap (2) of a vehicle. The cover or flap (2) is manually reversibly movable between open and closed positions. In the closed position, the cover or flap (2) is arranged flush with a vehicle outer shell (3), and in the open position the cover or flap (2) is arranged at least partially or regionally behind the vehicle outer shell (3). The actuating mechanism (1) includes a movement mechanism (3) operatively connected to the cover or flap (2) that, when transferring the cover or flap (2) from its closed position into its open position, first transfer the cover or flap (2) into an intermediate position in which the cover or flap (2) is located at least partially or regionally behind the vehicle outer shell (3) and then transfer the cover or flap (2) into its open position in an at least substantially and preferably purely rotational movement. According to the disclosure, it is provided in particular that the actuating mechanism (1) further includes a spring mechanism that is associated with the articulation mechanism (3) or is part of the articulation mechanism (3). The spring mechanism is configured so as to, when transferring the cover or flap (2) from its closed position into its open position or when transferring the cover or flap (2) from its open position into its closed position, apply a force component to the articulation mechanism (3) that supports the transfer of the cover or flap (2) at least into its open position or closed position.

### RELATED APPLICATION

The present application claims the benefit of German Patent Application No. 10 2023 103 576.2, filed Feb. 14, 2023, titled “Actuation Mechanism for Actuating a Cover or Flap of a Vehicle,” the contents of which are hereby incorporated by reference.

### BACKGROUND

In the automotive industry, doors and flaps are increasingly no longer only opened or closed manually, i.e., mechanically. Rather, the opening or closing movements are performed more frequently automatically, in particular electrically. For example, an electric motor is used here, which, when desired, drives a mechanism for opening or closing the doors and flaps. In order to generate a signal for opening or closing to such electric drives or the associated control devices, a switch can be provided, which generates the desired signal by an actuation of the user. Such switches can be configured as push-buttons, which, when pressed in by the user, generate the aforementioned signal. For the above-mentioned reasons, the problem addressed by the present disclosure is to specify a charging, service, or fueling flap of a vehicle or in the form of a cover or flap for sensor system, and in particular LIDAR system, covers of a vehicle.

### SUMMARY

The present disclosure relates generally to actuating mechanism, substantially as illustrated by and described in connection with at least one of the figures, as set forth more completely in the claims. For example, the disclosure relates to an actuating mechanism for actuating a cover or flap of a vehicle, in particular a cover or flap in the form of a charging, service, or fueling flap of a vehicle or in the form of a cover or flap for sensor system, and in particular LIDAR system, covers of a vehicle.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a cross-sectional view, an exemplary embodiment of the actuating mechanism according to the disclosure, wherein the cover of the charging, service, or fueling assembly or sensor system and in particular LIDAR system is in its closed position.

FIG. 2 illustrates schematically and in a cross-sectional view, the first exemplary embodiment of the actuating mechanism according to FIG. 1, wherein the cover or flap has been transferred from its closed position according to FIG. 1 in a rotational and translational movement, in particular superposed according to the superposition principle, i.e., in the direction of the inlet of the charging, service, or fueling assembly or into the inlet of the sensor system and in particular LIDAR system, inwardly into its intermediate position.

FIG. 3 illustrates schematically and in a cross-sectional view, the first exemplary embodiment of the actuating mechanism according to FIG. 1, wherein the cover or flap has been transferred from its intermediate position according to FIG. 2 into its dead-center position in at least a substantially purely rotational movement.

FIG. 4 illustrates schematically and in a cross-sectional view, the first exemplary embodiment of the actuating mechanism according to FIG. 1, wherein the cover or flap has been pivoted from its dead-center position according to FIG. 3 in at least substantially a purely rotational movement into its open position.

FIG. 5 illustrates schematically and in a cross-sectional view, the first exemplary embodiment of the actuating mechanism according to FIG. 1, wherein it is indicated how the cover or flap can be manually transferred from its open position according to FIG. 4 back towards the closed position of the cover or flap.

FIG. 6 illustrates schematically and in a cross-sectional view, the first exemplary embodiment of the actuating mechanism according to FIG. 1, wherein the cover or flap is present in the dead-center position upon transfer from the open position according to FIG. 4 or FIG. 5.

FIG. 7 illustrates schematically and in a cross-sectional view, the first exemplary embodiment of the actuating mechanism according to FIG. 1, wherein, starting from the dead-center position shown in FIG. 6, the cover or flap is (again) in the intermediate position in the course of the closing operation, comparable to the position in FIG. 2.

FIG. 8 illustrates schematically and in a cross-sectional view, the first exemplary embodiment of the actuating mechanism according to FIG. 1, wherein, starting from the intermediate position shown in FIG. 7, the cover or flap is again in its closed position according to FIG. 1.

FIG. 9 illustrates schematically and in a cross-sectional view, a further (second) exemplary embodiment of the actuating mechanism according to the disclosure, wherein the cover or flap of the charging, service, or fueling assembly or the sensor system and in particular LIDAR system is in its closed position.

FIG. 10 illustrates schematically and in a cross-sectional view, the second exemplary embodiment of the actuating mechanism according to FIG. 9, wherein the cover or flap has been transferred from its closed position according to FIG. 9 in a linear movement, i.e., into the inlet of the charging, service, or fueling assembly or sensor system and in particular LIDAR system, inwardly into its intermediate position.

FIG. 11 illustrates schematically and in a cross-sectional view, the second exemplary embodiment of the actuating mechanism according to FIG. 9, wherein, starting from the intermediate position shown in FIG. 10, the cover or flap is in a dead-center position.

FIG. 12 illustrates schematically and in a cross-sectional view, the second exemplary embodiment of the actuating mechanism according to FIG. 9, wherein the cover or flap has been pivoted from its dead-center position according to FIG. 11 in at least substantially a purely rotational movement into its open position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a further aspect of the disclosure, it relates to an assembly, in particular a sensor, preferably a LIDAR system assembly, or a charging, service, or fueling assembly for vehicles, wherein the assembly comprises, among other things, the actuating mechanism according to the disclosure.

The disclosure further relates to a vehicle having a corresponding sensor assembly, in particular a LIDAR system assembly, or having a charging, service, or fueling assembly.

Movable covers are used at various locations in the vehicle. In principle, these serve to conceal or cover an opening or surface to be covered in or on a vehicle. In particular, such covers are used for fueling flaps, charging flaps, water flaps, or other service flaps, for example. For example, fueling or charging flaps cover a fueling inlet (or charging inlet) used for refueling a vehicle with fuel or, for example, a urea solution, or for charging the battery of an electric or hybrid motor vehicle.

Further, corresponding covers cover sensor systems of vehicles, in particular LIDAR systems.

Vehicles with modern assistance systems often comprise LIDAR sensors, for example, which serve to detect objects in the vicinity of the vehicle. For this purpose, individual light pulses or laser beams are transmitted from the LIDAR sensor into the environment. Typically, LIDAR sensors for automotive applications emit laser beams in a wavelength range that is invisible to the human eye. This is usually infrared radiation with a wavelength of 800 nm to 2500 nm. If the single laser beam is reflected off of an object in the environment, for example a vehicle, back to the LIDAR sensor, the distance between the LIDAR sensor and the object can be deduced based on the time-of-flight of the single laser beam.

In order to emit the light pulses or laser beams in different directions, to receive them, and to direct them towards a detector, various mirror systems are known in the context of LIDAR sensors according to the prior art. With such mirror systems, the light pulse or laser beam can be directed in a particular direction of the environment. The environment is thus sampled with several thousand pulses of light or laser beams. For this purpose, the mirror systems for receiving the laser beams reflected back to the LIDAR sensor must be precisely aligned in the direction of transmission.

Due to the necessary precision of a LIDAR sensor assembly, this assembly is a constructively expensive and costly unit, so that the LIDAR assembly must be kept as protected as possible and not accessible from the outside in the parked state of the vehicle. Moreover, in the parked state of the vehicle, the LIDAR assembly is intended to be protected from external influences or temperature, humidity, or the like. Thus, it is desirable to accommodate the LIDAR sensor technology in a sensor inlet, which can be protected with a cover.

Such covers are often connected to a hinge arm of an actuating mechanism, which forms the corresponding flap that can be pivoted between an open position that uncovers the opening and a closed position that covers the opening.

Known actuating mechanisms can be designed so as to move the covers in various ways between the closed position and the open position. For example, actuating mechanisms that pivot the cover outward are known, in particular.

In addition to a frequently low user comfort when covering and releasing, the disadvantage of such actuating mechanisms is in particular the relatively high space requirement, for example of electric vehicles during a charging operation. The high space requirement results from the covers being pivoted outwardly when charging connectors are released and often projecting from the vehicle at a 90° angle in an open state.

The covers projecting from the vehicle pose a sometimes difficult-to-see obstacle for pedestrians, in particular, with which they can collide. In this case, not only personal injury but also damage to the cover itself can occur. In addition, the covers protruding from the vehicle often fall victim to vandalism, because the covers can easily be bent off of a vehicle due to their unfavorable angle.

Moreover, protruding covers increase the air resistance of the vehicle when the vehicle travels, for example when the covers are used in connection with a LIDAR sensor system.

In this respect, actuating mechanisms are preferred which are configured so as to move the cover behind the vehicle outer shell and thus release the opening.

In this context, for example, a mechanism is known from the publication DE 20 2021 001 685 U1, with which a cover is first pulled behind the vehicle body in a linear movement proceeding from a closed position, wherein the cover is subsequently pivoted into the open position behind the vehicle body. For the actuating mechanism, a gear train having a rack is used.

The actuating mechanisms known from the prior art for actuating a cover or flap of a vehicle, for example the actuating mechanism known from publication DE 20 2021 001 685U1, generally comprise an electromotive drive with which the cover or flap can be moved from the closed position into the open position (and vice versa). The in particular electromagnetic drive is operatively connected to the associated joint mechanism of the cover or flap.

The disadvantage of such approaches can be seen in the fact that electromotive drives are typically operatively connected to the joint mechanism via a transmission.

These are typically self-inhibiting transmissions. “Self-inhibiting” means that the drive shaft of the transmission no longer rotates and is thus blocked when a torque is applied. The self-inhibition means that the cover or flap can no longer be manually actuated as needed in order to manually transfer the cover or flap from the closed position into the open position, for example in the event of a failure of the electrical supply to the electric drive or in the event of a fault of the electric drive.

In particular, the gear boxes associated with the electric drive, which are usually arranged between the electric drive on the one hand and the joint mechanism of the cover or flap, are not designed to be reversible. This carries the risk that, in the event of a failure or a fault of the electric drive or a control device associated with the electric drive, the cover or flap can also no longer be manually transferred from its open position into the closed position.

Even if a transmission associated with the electric drive, which operatively connects the drive shaft of the electric drive to the joint mechanism, is not configured as a self-inhibiting transmission and/or a reversible transmission, it is generally not avoidable that, due to an actuator play which can settle in over time, or which also varies depending on the ambient temperature, the cover or flap is non-reproducibly transferable into the open position or the closed position.

Based on these concerns, the problem addressed by the disclosure is thus to specify an actuating mechanism for actuating a cover or flap of a vehicle, wherein the actuating mechanism allows for a complex movement pattern of the cover or flap in a simple design.

In particular, the actuating mechanism is intended to enable a reproducible movement pattern of the cover or flap. Moreover, the pivoting mechanism associated with the actuating mechanism should operate in the wet range in as low-wear a manner as possible.

This underlying problem of the disclosure is solved in particular by the subject-matter of independent claim 1, wherein advantageous further developments of the actuating mechanism according to the disclosure are specified in the dependent claims 2 to 14.

Accordingly, the disclosure relates in particular to an actuating mechanism for actuating a cover or flap of a vehicle, wherein the cover or flap is reversibly movable, in particular manually, between a closed position, in which the cover or flap is arranged in particular flush and preferably strake-flush with a vehicle body and in particular a vehicle outer shell, and an open position in which the cover or flap is arranged at least partially or regionally behind the vehicle body and in particular the vehicle outer shell.

The cover or flap is in particular a cover or flap in the form of a charging, service, or fueling flap of a vehicle or in the form of a cover or flap for sensor and in particular LIDAR system coverage of a vehicle.

The actuating mechanism according to the disclosure comprises a movement mechanism, which is in particular connected to the rear side of the cover or flap, which is designed in particular in the form of a joint mechanism or in the form of a guide mechanism, and, upon transfer of the cover or flap from its closed position into its open position, is configured so as to first transfer the cover or flap into an intermediate position, in which the cover or flap is located at least partially or regionally behind the vehicle body and in particular behind the vehicle outer shell, and then transfer the cover or flap into its open position in an at least substantially and preferably purely rotational movement.

Accordingly, the actuating mechanism according to the disclosure is an actuating mechanism that is capable of moving a cover or flap between an open position and a closed position and vice versa, wherein the actuating mechanism can in particular automatically expose or close an opening in a vehicle contour, for example a vehicle body, wherein in particular an interface can be provided within the opening in the vehicle contour, which interface is set back in relation to the vehicle contour in the direction of the vehicle interior and is arranged in a stationary manner on the vehicle.

The actuating mechanism according to the disclosure is characterized in particular in that it further comprises a spring mechanism, which is associated with the movement mechanism or is part of the movement mechanism.

According to a first option, when transferring the cover or flap from its closed position into its open position, and in particular when transferring the cover or flap from its intermediate position into its open position, the spring mechanism is configured so as to apply a first force component to the movement mechanism which supports the transfer of the cover or flap at least into its open position.

According to an alternative second option, when transferring the cover or flap from its open position into its closed position, and in particular when transferring the cover or flap from its intermediate position into its closed position, the spring mechanism is configured so as to apply a first force component to the movement mechanism which supports the transfer of the cover or flap at least into its closed position.

By providing such a spring mechanism, the fail-safe, functional, and operational safety of the actuating mechanism is increased in an easy-to-implement, yet effective manner.

If the actuating mechanism is further equipped with an electric drive actuator, which is operatively connected to the movement mechanism so that the cover or flap is electromotively transferable from the closed position into the open position (and vice versa), the spring mechanism serves as a redundancy.

Moreover, the spring mechanism offers the further advantage that a significantly lower torque or torque of force must be provided by an optionally provided electromotive drive in order to transfer the cover or flap from its closed position into its open position, or vice versa from its open position into its closed position, because the spring mechanism provides a biasing force (first force component), which is applied to the movement mechanism in order to support the transfer of the cover or flap at least into its open position or at least into its closed position.

A possibly provided electromotive drive can thus be designed smaller, which has significant advantages in view of the generally limited available design space.

It is also effectively ensured by the provision of the spring mechanism that, despite a relatively small electromotive drive, a relatively large torque of force can be exerted when transferring the cover or flap from its closed position into the open position or from its open position into the closed position, as a result of which an existing icing can be safely resolved without the electromotive actuator in particular having to be designed to be accordingly over-sized.

However, the disclosure is not limited to embodiments in which an electric drive is associated with the actuating mechanism.

Also contemplated are design variants in which no actuator, in particular no electromotive actuator, is used, and in which the cover or flap is manually transferable from the closed position into the open position (and vice versa).

If, nevertheless, an actuator, in particular having an electromotive design, is used in order to operate the cover or flap as needed, the spring mechanism offers the additional benefit that any existing actuator play has no effect on a reproducible position of the cover or flap at least in its open position or closed position, because, due to the biasing force applied on the cover or flap by the spring mechanism, the cover or flap is always pressed into the target position despite any existing actuator play when the cover or flap is in its open or closed position.

According to preferred realizations of the actuating mechanism according to the disclosure, it is provided that, when transferring the cover or flap from its closed position into its open position, and in particular when transferring the cover or flap from its intermediate position into its open position, the spring mechanism is configured so as to apply a first force component to the movement mechanism which supports the transfer of the cover or flap into its open position at least until the cover or flap is in a dead-center position between the intermediate position and the open position, wherein the dead-center position of the cover or flap is in particular a bistable position of the cover or flap.

Alternatively, it is provided that, when transferring the cover or flap from its open position into its closed position, and in particular when transferring the cover or flap from its intermediate position into its closed position, the spring mechanism is configured so as to apply a first force component to the movement mechanism which supports the transfer of the cover or flap into its closed position at least until the cover or flap is in a dead-center position between the open position and the closed position, wherein the dead-center position of the cover or flap is in particular a bistable position of the cover or flap.

The dead-center position of the cover or flap refers to an in particular bistable position of the cover or flap, in which the connecting levers and/or joints of the movement mechanism of the actuating mechanism and the acting force vectors, in particular the acting force vectors exerted by the spring mechanism, lie on a common straight line.

In a particularly easy-to-implement design variant of the last-mentioned aspect, it is provided that the spring mechanism is configured as a dead-center spring lever mechanism, and in particular an over-dead-center spring lever mechanism, or is part of a dead-center spring lever mechanism, and in particular an over-dead-center center spring lever mechanism, wherein, upon overcoming the dead-center position of the cover or flap towards the open position of the cover or flap, the dead-center spring lever mechanism and in particular the over-dead-center spring lever mechanism is configured so as to apply a second force component to the movement mechanism, which supports the transfer of the cover or flap from the dead-center position at least into the open position.

Alternatively, it is provided that the spring mechanism is configured as a dead-center spring lever mechanism, and in particular an over-dead-center spring lever mechanism, or is part of a dead-center spring lever mechanism, and in particular an over-dead-center spring lever mechanism, wherein, upon overcoming the dead-center position towards the closed position of the cover or flap, the dead-center spring lever mechanism and in particular the over-dead-center spring lever mechanism is configured so as to apply a second force component to the movement mechanism, which supports the transfer of the cover or flap from the dead-center position at least into the closed position.

In other words, in these design variants, it is provided that the cover or flap is first transferred into the aforementioned intermediate position, starting from its closed position. Subsequently, the cover or flap is transferred into the dead-center position, in particular by the impact of the first force component of the spring mechanism on the movement mechanism.

Alternatively, it is provided that the cover or flap, starting from its open position, in particular due to the impact of the first force component of the spring mechanism on the movement mechanism, is transferred into the dead-center position.

Without external impacts on the cover or flap in the dead-center position, it remains there. This state changes only by the action of a further force component. If this further force component is a (second) force component acting in the open position of the cover or flap, the cover or flap is transferred from the dead-center position into the open position with at least simultaneous support by the spring mechanism.

Thus, it is generally contemplated that the spring mechanism comprises at least one dead-center spring and, in particular an over-dead-center spring, which is attached to a lever or to a lever region of the movement mechanism on the one hand and to a fixed point in relation to the lever or the lever region of the movement mechanism on the other hand. The lever or lever region of the movement mechanism is mounted rotatably about a pivot point, wherein preferably the at least one dead-center spring and in particular the over-dead-center spring is attached to the lever or lever region in an in particular slightly offset position in relation to the pivot point of the lever or lever region. Preferably, in this design variant, the at least one dead-center spring, and in particular the over-dead-center spring, is configured as a compression spring.

According to embodiments of the actuating mechanism according to the disclosure, said actuating mechanism is configured such that, in particular, the cover or flap can be moved from its open position into its intermediate position or vice versa by applying manual force on the cover or flap.

According to a design variant, it can be appreciated here that the spring mechanism is configured, at least at that time, so as to preferably automatically transfer the cover or flap into its dead-center position and subsequently, in particular after overcoming the dead-center position, preferably automatically transfer the cover or flap into its closed position by applying further manual force to the cover or flap.

The same applies in the reverse case, in which the spring mechanism is configured, at least at that time, so as to preferably automatically transfer the cover or flap into its dead-center position, and subsequently, in particular after overcoming the dead-center position, preferably automatically transfer the cover or flap into its open position by applying further manual force to the cover or flap.

In design variants in which the cover or flap is manually transferable from the open position into the closed position (and/or vice versa), the cover or flap should preferably comprises an actuating region which is arranged in particular on the rear side of the cover or flap and is in particular manually actuatable or graspable, which is configured such that the actuating region is manually actuatable or graspable in the open position of the cover or flap such that, in particular in the direction of a biasing force applied by the spring mechanism to the movement mechanism and/or the cover or flap, the cover or flap is transferable from its open position into its dead-center position of the cover or flap and/or into the intermediate position of the cover or flap.

Alternatively, the cover or flap comprises an actuating region which is arranged in particular on the rear side of the cover or flap and is in particular manually actuatable or graspable, which is configured such that the actuating region is manually actuatable or graspable in the open position of the cover or flap such that, in particular counter to a biasing force applied by the spring mechanism to the movement mechanism and/or the cover or flap, the cover or flap is transferable from its open position into its dead-center position of the cover or flap and/or into the intermediate position of the cover or flap.

With regard to the movement mechanism of the actuating mechanism according to the disclosure, different design variants can be considered.

According to a design variant, the movement mechanism, which is in particular operatively connected to the rear side of the cover or flap, is configured so as to, when transferring the cover or flap from its closed position into its open position, first transfer the cover or flap into the intermediate position in a linear movement, in particular a pure linear movement, and then transfer the cover or flap into the open position in an at least substantially and preferably purely rotational movement.

Here, for example, a joint or actuating mechanism can be used, as is known at least in principle from the publication DE 20 2021 001 685U1. In other words, in order to transfer the cover or flap from its closed position into the open position via the intermediate position, a movement mechanism operatively connected to the rear side of the cover or flap, which movement mechanism comprises a gear train with a rack, can be used.

Alternatively to such an actuating mechanism consisting of a gear train having a corresponding rack, the movement mechanism, which is in particular operatively connected to the rear side of the cover or flap, can comprise a guide mechanism, which is configured so as to, when transferring the cover or flap from its closed position into its intermediate position, realize a corresponding linear movement of the cover or flap relative to the vehicle body and in particular relative to the vehicle outer shell, and which is further configured so as to, when transferring the cover or flap from its intermediate position into its open position, realize an at least substantially and preferably purely rotational movement of the cover or flap relative to the vehicle body and in particular relative to the vehicle outer shell.

In particular, a sliding guide mechanism and/or a cam mechanism can be a suitable guide mechanism.

According to an embodiment of the movement mechanism, it comprises at least one lever arm which is or can be connected to the cover or flap, in particular at its back, and, upon actuation of drive, in particular an electromotive drive, associated with the actuating mechanism, is designed so as to pick up a rotary motion from the drive shaft and convert this into a motion, in particular a displacement and pivoting motion, of the cover.

For this purpose, the at least one lever arm can comprise a drive surface that communicates with the drive shaft of the in particular electromotive drive such that a rotation of the drive shaft is transmitted to the at least one lever arm via the drive surface, wherein the drive surface comprises a first region that is configured such that a rotation of the drive shaft moves the lever arm in a first direction when the lever arm communicates with the drive shaft via the first region, and wherein the drive surface comprises a second region that is designed such that a rotation of the drive shaft moves the lever arm in a second direction when the lever arm communicates with the drive shaft via the second region, when the lever arm is in communication with the drive shaft via the second region.

In particular, it can be appreciated that the first region of the drive surface of the at least one lever arm is substantially linear or runs substantially in a straight line, wherein the second region of the drive surface of the at least one lever arm is designed in a curvilinear fashion, in particular in an arc-shaped fashion.

The first portion of the drive surface of the at least one lever arm should preferably be configured immediately adjacent to the second portion of the drive surface of the at least one lever arm.

It is also contemplated in this context, for example, that the drive surface of the at least one lever arm is configured as a rack, which is operatively connected to a gear wheel driven by the drive shaft.

Alternatively or additionally, it is contemplated that the lever arm comprises a guide groove, which is configured so as to guide movement of the lever arm in the first direction and the second direction. In this context, it can be provided in particular that the guide groove is configured as an elongated hole, which extends parallel to the first region of the drive surface.

Alternatively or additionally, it is contemplated that the at least one lever arm is pivotably supported about a pivot axis, wherein the pivot axis extends into the guide groove.

Advantageously, the at least one lever arm comprises an end stop which is arranged adjacently to the arc-shaped region, in particular on a side of the lever arm that is located opposite the linear region.

Alternatively to the aforementioned design variants of the movement mechanism assigned to the actuating mechanism, the movement mechanism, which is in particular operatively connected to the rear side of the cover or flap, is configured so as to, when transferring the cover or flap from its closed position into its open position, first transfer the cover or flap into the intermediate position in a rotational and translational movement, in particular superposed according to the superposition principle, and then transfer the cover or flap into the open position in an at least substantially and preferably purely rotational movement.

The advantages achievable with this design of the movement mechanism are clear: due to the fact that, upon actuation of an optional and in particular electromotive drive assigned to the actuating mechanism proceeding from the closed position of the cover or flap, it is initially moved in a rotational and translational movement, in particular superposed according to the superposition principle, into an intermediate position, it is ensured that a gasket region between the cover or flap and the edge region of the opening covered by the cover or flap is unevenly stressed. In other words, by moving the cover or flap into the intermediate position in a rotational and translational movement, in particular superposed according to the superposition principle, a first region of the edge of the cover or flap detaches faster from the edge region of the opening than an opposite region of the cover or flap.

In this way, a greater moment of force is exerted on the region of the cover or flap that detaches more quickly from the edge region of the opening, as a result of which a possibly existing icing can be safely detached without the optionally provided and in particular electromotive actuator having to be designed in a correspondingly oversized manner.

The movement mechanism is thus in particular configured so as to do the following:
(a) proceeding from the closed position of the cover or flap, first move the cover or flap into the intermediate position in the rotational and translational movement, in particular superposed according to the superposition principle, in which the cover is in a position in which the cover is pivoted relative to the closed position of the cover about a first axis of rotation and is at least partially or regionally offset in comparison to the closed position backwards towards the interior of the vehicle; and
(b) subsequently, proceeding from the intermediate position of the cover or flap, pivot the cover or flap in the at least substantially and preferably purely rotational movement about a second axis of rotation into the open position, in which the cover or flap is arranged at least partially or regionally behind the vehicle body and in particular behind the vehicle outer shell.

In particular, in the intermediate position, the cover is in a position which is at least partially or regionally rearwardly offset towards the interior of the vehicle, compared to the closed position.

In order to achieve a in particular compact construction of the actuating mechanism, it is provided according to further developments of the last mentioned design variants of the movement mechanism that the first axis of rotation about which the cover or flap is movable into the intermediate position in a rotational and translational movement, in particular superposed according to the superposition principle, matches the second axis of rotation about which the cover is flap is pivotable into the open position proceeding from the closed position.

In this context, in particular, it is sensible that the first and preferably also the second axis of rotation matches an axis of rotation of a drive shaft of the in particular optionally provided and preferably electromotively configured drive.

According to one aspect of the disclosure, in order to protect the interior of the inlet that can be covered by the cover or flap against weather effects and in particular against moisture, it is provided that the cover or flap is associated with a gasket which partially or regionally surrounds the cover and is configured so as to seal off a region between the cover or flap and the vehicle body, in particular the vehicle outer shell, at least in the closed position of the cover or flap.

The movement mechanism is in particular configured such that, upon actuation of the drive, proceeding from the closed position of the cover or flap, it moves said cover or flap to the intermediate position in a rotational and translational movement, in particular superposed according to the superposition principle, in such a way that the gasket, which in particular partially or regionally surrounds the cover or flap, moves faster in a first region of the gasket relative to the cover or flap or relative to the vehicle body, in particular the vehicle outer shell, than in a second region of the gasket that in particular lies opposite the first region of the gasket. In this way, an ice-breaking function is effectively implemented.

In order to realize the movement mechanism of the actuating mechanism in as simple a manner as possible and nevertheless effectively, it is provided in particular that the movement mechanism comprises a lever rotatably supported about the first pivot axis, in particular a push-out lever, and a hinge arm, wherein a first end region of the hinge arm is preferably fixedly connected or connectable to in particular the rear side of the cover, and wherein an opposite second end region of the hinge arm is connected to the lever in an articulated manner.

In this context, it is sensible that, at least over a defined or definable angular range, the hinge arm is pivotable via its second end region about a third axis of rotation relative to the lever, wherein the third axis of rotation preferably extends parallel to the first axis of rotation about which the lever is rotatably supported.

Alternatively or in addition to the last mentioned aspect, it is contemplated that the lever comprises a tappet, which is configured so as to also move and in particular rotate the hinge arm when the lever is moved.

In this context, it is contemplated, for example, that, proceeding from a resting position of the lever in which the cover is in its closed position, the tappet is configured so as to enter into contact with the hinge arm only after rotation of the lever about a defined or definable angular range about the first axis of rotation of the lever, wherein, at that time and upon a further rotation of the lever, the lever is additionally pivoted with the hinge arm about the first axis of rotation of the lever.

In this way, without the use of a gear train, the relatively complex movement sequence of the cover is realizable in a reproducible manner.

It is contemplated in this context, in particular, that after rotation of the lever about the defined or definable angular range about the first axis of rotation of the lever, the cover is in its intermediate position.

In principle, it is contemplated that a spring mechanism and/or a mechanical blockage is associated with the movement mechanism, which is configured so as to hold the hinge arm and the lever together when the tappet enters or has entered into contact with the hinge arm.

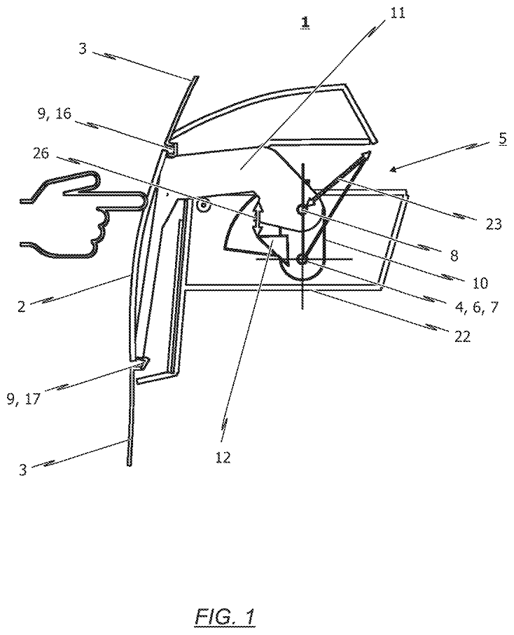

Firstly, in the following, a first exemplary embodiment of the actuating mechanism 1 according to the disclosure is described in further detail in relation to the drawings in FIG. 1 to FIG. 8.

While it is generally contemplated that the actuating mechanism 1 can be equipped with an actuator, in particular an electromotive actuator (electric drive) according to the first exemplary embodiment of FIG. 1 to FIG. 8, this is not to be considered limiting, in principle.

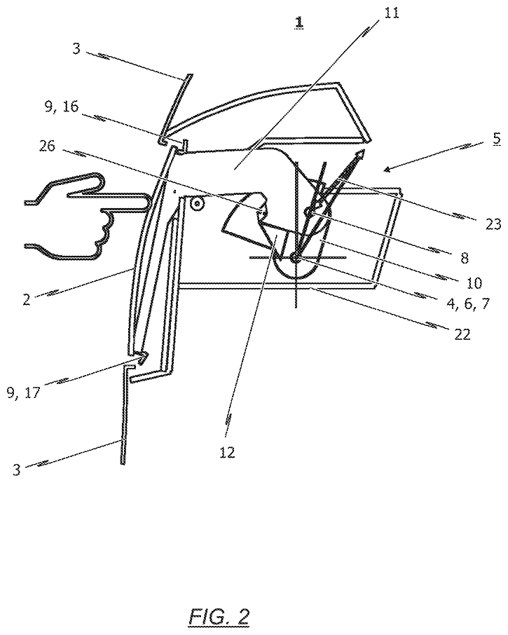

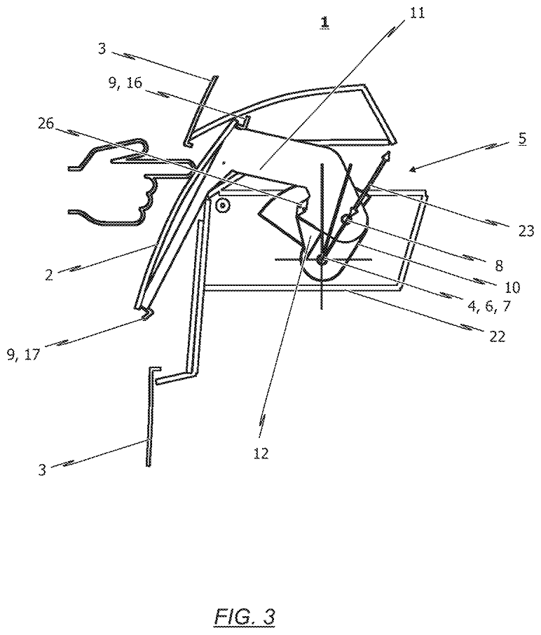

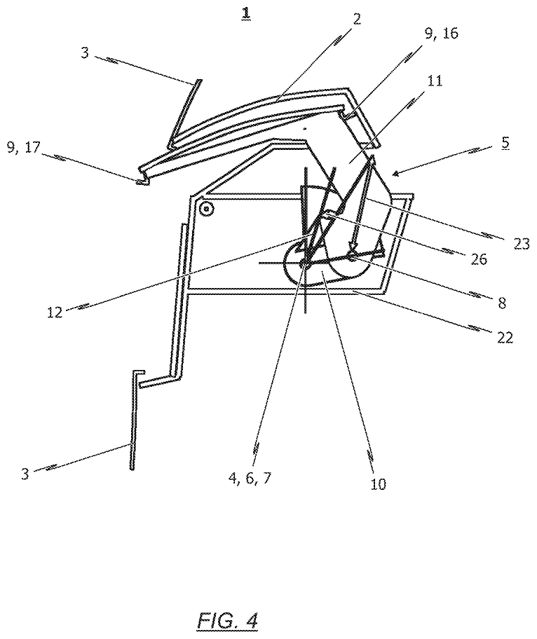

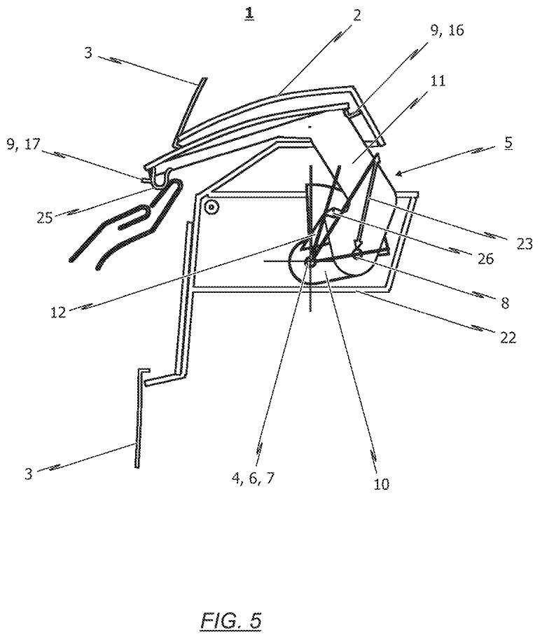

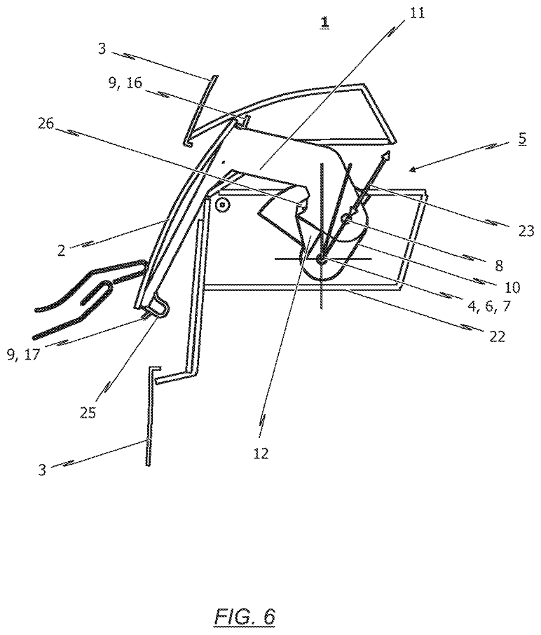

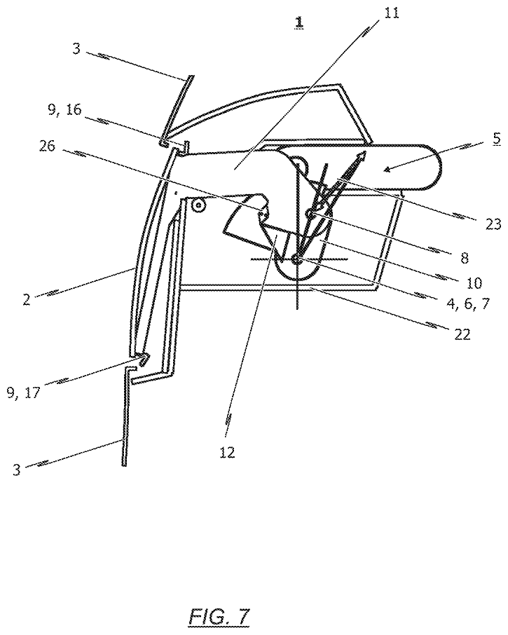

Rather, the actuating mechanism 1 is also suitable for manually, in particular purely manually, transferring a cover or flap 2 (as indicated in the drawings) from the closed position of the cover or flap 2 according to FIG. 1 into the intermediate position of the cover or flap 2 according to FIG. 2 and then into the dead-center position of the cover or flap 2 according to FIG. 3 and finally into the open position of the cover or flap 2 according to FIG. 4 and then back from the open position (see FIG. 5) into the dead-center position of the cover or flap 2 according to FIG. 6 and then into the intermediate position according to FIG. 7.

Apart from these comments, the actuating mechanism 1 according to the first exemplary embodiment of FIG. 1 to FIG. 8 can also very well comprise a drive (not shown), in particular in the form of an electric drive, having a corresponding drive shaft.

The actuating mechanism 1 comprises in particular a movement mechanism 5 that is preferably operatively connected to the rear side of the cover or flap 2 and to the drive.

A combined view of FIG. 1 to FIG. 4 reveals that, upon actuation of the drive and/or upon manual actuation proceeding from the closed position of the cover or flap 2 according to FIG. 1, it initially moves said cover or flap in a rotational and translational movement, in particular superposed according to the superposition principle, into the intermediate position according to FIG. 2, in which the cover or flap 2 is in a position where the cover or flap 2 is pivoted relative to the closed position of the cover or flap 2 about a first axis of rotation 6 and is located at least partially or regionally behind the vehicle body and in particular behind the vehicle outer shell 3.

Upon a further actuation of the drive or upon a further manual actuation, proceeding from the intermediate position of the cover or flap 2 according to FIG. 2, the cover or flap is subsequently pivoted in an at least substantially and preferably purely rotational movement about a second axis of rotation 7 into the open position, in which the cover or flap 2 is arranged at least partially or regionally behind the vehicle body and in particular behind the vehicle outer shell 3.

In the embodiment shown in the illustrations, it is provided that the first axis of rotation 6 about which the cover or flap 2 is movable into the intermediate position in a rotational and translational movement, in particular superposed according to the superposition principle, matches the second axis of rotation 7 about which the cover or flap 2 is pivotable into the open position proceeding from the intermediate position. In particular, it is provided that the first and second axis of rotation 6, 7 match the axis of rotation of the drive shaft 3 of the optionally provided drive.

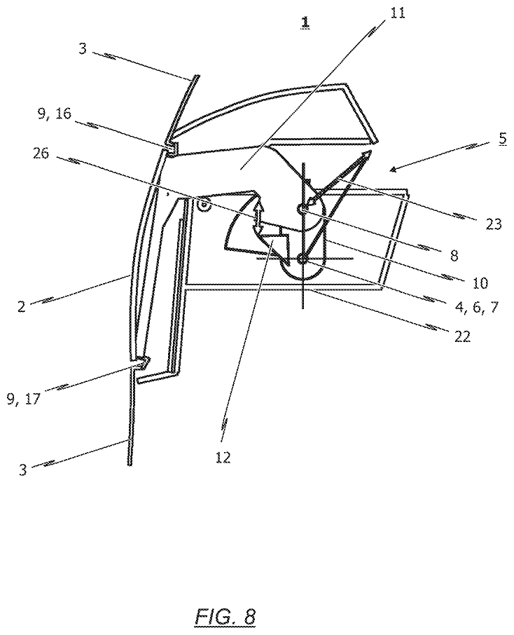

In the drawings, it is further indicated that the cover or flap 2 is associated with a gasket 9 that partially or regionally surrounds the cover or flap 2 and is configured so as to seal off a region between the cover or flap 2 and the vehicle body, in particular the vehicle outer shell 3, at least in the closed position of the cover or flap 2 (cf. for example FIG. 1 or FIG. 8).

The movement mechanism 5 is in particular configured such that, upon actuation of the optionally provided drive, or upon manual actuation, proceeding from the closed position of the cover (cf. for example FIG. 1), it moves said cover or flap 2 into the intermediate position in a rotational and translational movement, in particular superposed according to the superposition principle (cf. FIG. 2), in such a way that the gasket 9, which in particular partially or regionally surrounds the cover or flap 2, moves faster in a first region 16 of the gasket 9 (here: in an upper region of the gasket 9) relative to the cover or flap 2 or relative to the vehicle body, than in a second region 17 of the gasket 9 that in particular lies opposite the first region 16 of the gasket 9.

In the first exemplary embodiment of the actuating mechanism 1 shown in the drawings, it is provided that the movement mechanism 5 comprises a lever 10, in particular a push-out lever, which is rotatably supported about the first axis of rotation 6, and a hinge arm 11, wherein a first end region of the hinge arm 11 is preferably fixedly connected or connectable to the rear side of the cover or flap 2, in particular. On the other hand, an opposite second end region of the hinge arm 11 is connected to the lever 10 in an articulated manner.

It is provided that, at least over a defined or definable angular range, the hinge arm 11 is pivotable via its second end region about a third axis of rotation 8 relative to the lever 10, wherein the third axis of rotation 8 preferably extends parallel to the first axis of rotation 6 about which the lever 10 is rotatably supported.

Further, in the first embodiment of the actuating mechanism 1 according to the disclosure, it is provided that the lever 10 comprises a tappet 12, which is configured so as to also move and in particular rotate the hinge arm 11 when the lever 10 is moved.

In particular, proceeding from a resting position of the lever 10 in which the cover or flap 2 is in its closed position (cf. for example FIG. 1), the tappet 12 is configured so as to enter into contact with the hinge arm 11 only after rotation of the lever 10 about a defined or definable angular range about the first axis of rotation 6 of the lever 10 (cf. for example FIG. 2), wherein, at that time and upon a further rotation of the lever 10, the lever 10 is additionally pivoted with the hinge arm 11 about the first axis of rotation 6 of the lever 10 (cf. for example FIGS. 3 and 4).

The first exemplary embodiment of the actuating mechanism 1 according to the disclosure is in particular also characterized in that the actuating mechanism 1 comprises a spring mechanism associated with the movement mechanism 5 or is part of the movement mechanism 5.

The spring mechanism is configured so as to apply a first force component to the movement mechanism 5 which supports the transfer of the cover or flap 2 at least into its closed position when transferring the cover or flap 2 from its open position (cf. FIG. 4) into its closed position (cf. FIG. 1), and in particular when transferring the cover or flap 2 from its open position (cf. FIG. 4) into its intermediate position (cf. FIG. 2).

Specifically, in the first exemplary embodiment of the actuating mechanism 1 according to the disclosure, the spring mechanism is configured so as to apply a first force component to the movement mechanism 5, which supports the transfer of the cover or flap 2 at least into its closed position, when transferring the cover or flap 2 from its open position into its closed position, and in particular when transferring the cover or flap 2 from its open position according to FIG. 4 into its intermediate position according to FIG. 2, until the cover or flap 2 in its dead-center position according to FIG. 3 between the intermediate position according to FIG. 2 and the open position according to FIG. 4.

In the first exemplary embodiment of the actuating mechanism 1 according to the disclosure, it is provided that the spring mechanism is configured as a dead-center spring lever mechanism and in particular as an over-dead-center spring lever mechanism or is part of such a dead-center spring lever mechanism and in particular an over-dead-center spring lever mechanism. After overcoming the dead-center position according to FIG. 3, a second force component is applied to the movement mechanism 5, which supports the transfer of the cover or flap 2 at least from the dead-center position according to FIG. 3 into the closed position according to FIG. 1.

Specifically, in the first exemplary embodiment of the actuating mechanism 1 according to the disclosure, it is provided that the spring mechanism comprises a dead-center spring, in particular an over-dead-center spring 23, which is attached to a lever or lever region of the movement mechanism 5 on the one hand and to a fixed point in relation to the lever or lever region of the movement mechanism 5 on the other hand, wherein the lever or lever region of the movement mechanism 5 is rotatably supported about a pivot point, and wherein the dead-center spring and in particular over-dead-center spring 23 is attached to the lever or lever region in a slightly offset position in relation to the pivot point 4, 6, 7 of the lever or lever region.

In the first exemplary embodiment, the dead-center spring and in particular the over-dead-center spring 23 are configured as a compression spring.

As can be seen in particular in the illustration in FIG. 1 and FIG. 2, the actuating mechanism 1 is configured according to the first exemplary embodiment such that, in particular by applying manual force to the cover or flap 2, the cover or flap 2 can be transferred from its closed position (cf. FIG. 1) into its intermediate position (cf. FIG. 2).

In particular, the spring mechanism is configured such that the cover or flap 2 is transferred into its dead-center position according to FIG. 3 counter to the biasing force of the spring mechanism, and then, and in particular after overcoming the dead-center position, the cover or flap 2 is subsequently transferred into its open position according to FIG. 4 by applying manual force on the cover or flap 2.

As can be seen in particular in the illustration in FIG. 5, according to the first exemplary embodiment, it is provided in particular in the actuating mechanism 1 that the cover or flap 2 comprises an actuating region 25, which is arranged in particular on the rear side of the cover or flap 2 and is in particular manually actuatable or graspable (cf. FIG. 5 and FIG. 6).

The actuating region 25 is configured so as to be in particular manually actuatable and in particular graspable in the open position of the cover or flap 2, as schematically indicated in FIG. 5.

In this way, in particular in the direction of a biasing force exerted by the spring mechanism on the movement mechanism 5 or on the cover or flap 2, the cover or flap 2 can be moved from its open position according to FIG. 5 into the dead-center position according to FIG. 6.

Subsequently, as indicated in FIG. 6, the cover or flap 2 can also be transferred back into the intermediate position according to FIG. 7 from the outside, similarly by applying manual force to the cover or flap 2.

Preferably, a spring mechanism 26 and/or a mechanical blockage is associated with the movement mechanism 3, which is configured so as to hold the hinge arm 11 and the lever 10 together when the tappet 12 enters or has entered into contact with the hinge arm 11.

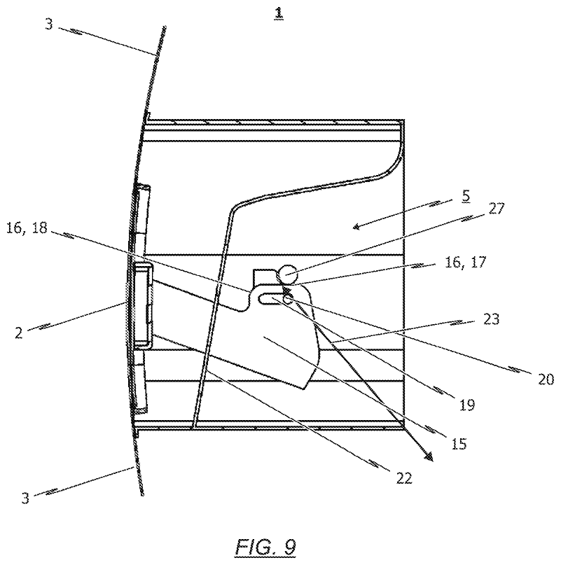

An alternative embodiment of the actuating mechanism 1 according to the disclosure is described below with reference to the drawings in FIG. 9 to FIG. 12.

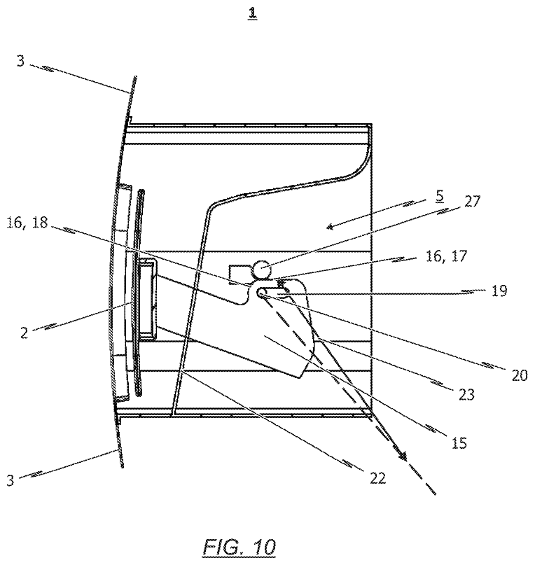

The actuating mechanism 1 according to the further (second) exemplary embodiment of the disclosure is characterized in particular in that the movement mechanism 5, which is operatively connected to the rear side of the cover or flap 2, is configured so as to transfer the cover or flap 2 into the intermediate position shown in FIG. 10, first in a linear movement and in particular in a pure linear movement, upon transfer of the cover or flap 2 out of its closed position according to FIG. 9.

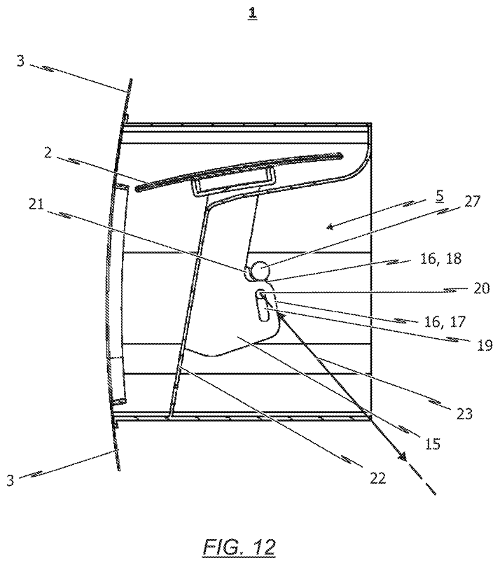

The cover or flap 2 is then transferred into the open position shown in FIG. 12 in the course of an in particular purely rotational movement.

The second exemplary embodiment of the actuating mechanism 1 according to the disclosure is also characterized in particular in that the movement mechanism 5, which is operatively connected to the rear side of the cover or flap 2, comprises a guide mechanism, which, upon transfer of the cover or flap 2 from its closed position (cf. FIG. 9) into its intermediate position according to FIG. 10, is configured so as to realize a corresponding linear movement of the cover or flap 2 relative to the vehicle body and in particular relative to the vehicle outer shell 3.

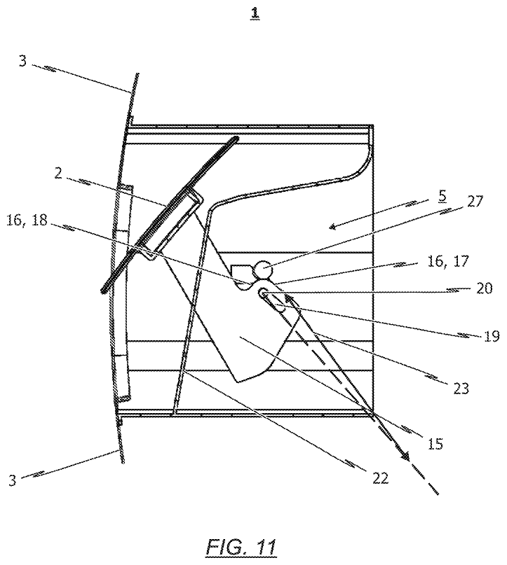

Then, with the aid of the movement mechanism 5, the cover or flap 2 is transferred from its intermediate position according to FIG. 10 in a preferably purely rotational movement relative to the vehicle body and in particular relative to the vehicle outer shell 3 into the dead-center position shown in FIG. 11 or subsequently into the open position shown in FIG. 12.

In the second exemplary embodiment of the actuating mechanism 1 according to the disclosure, the movement mechanism 5 comprises a lever arm 15.

The lever arm 15 is connected to a cover or flap 2 at a first end. It is noted here that only a single lever arm 15 can be seen in FIG. 9.

However, it is generally contemplated that the movement mechanism 5 preferably comprises two or more substantially identical lever arms, which are attached to sides of the cover or flap 2 that are positioned in particular opposite one another. These lever arms can be connected to one another and to the cover or flap 2 via a corresponding synchronization element.

The lever arm 15 used in the second exemplary embodiment of the actuating mechanism 1 according to the disclosure comprises a drive surface 16.

The drive surface 16 is provided on a second end of the lever arm 15, which is located substantially opposite the first end. The drive surface 16 is arranged on an outer surface of the lever arm 15.

The drive surface 16 is in contact with a drive gear 27, for example a gear wheel.

The drive gear 27 is driven by a drive shaft of a drive, in particular an electromotive drive (electric drive), not shown in FIG. 9 to FIG. 12. The drive gear 27 can, in particular, be rotated clockwise and counterclockwise.

The lever arm 15 further comprises a guide groove 19, which is formed as an elongated hole. A pivot bolt defining a pivot axis 20 is received in the guide groove 19.

In the closed position of the cover or flap 2 as shown in FIG. 9, the pivot axis 20 is arranged at a first end of the guide groove 19. The lever arm 15 can be translationally moved in relation to the pivot axis 20 via the guide groove 19.

The actuating mechanism 1 is in particular accommodated within, i.e., behind, the vehicle body/vehicle outer shell 3.

An inlet 22 is provided on the interior of the vehicle body/vehicle outer shell 3, which, for example, can be used in order to accommodate charging or fueling modules (e.g., charging plugs or fueling ports) or for accommodating a sensor assembly, in particular a LIDAR sensor assembly.

The inlet 22 divides the interior of the outer shell 3 of the vehicle into an outer region and an inner region. The outer region is difficult to access from the vehicle exterior when the cover or flap 2 is open (cf. for example FIG. 12). The interior region is not accessible from the outside, regardless of whether the cover or flap 2 is open or closed.

As can be further seen in particular in the illustration in FIG. 9, the in particular electromotive drive, the pivot axis 20, and the drive surface 16 are located behind the inlet 22, i.e., in the internal region. Only a front portion of the lever arm 15, which is connected to the cover or flap 2 via the first end, extends through corresponding openings of the inlet 22, for example through elongated holes of the inlet 22. Thus, the drive parts of the actuating mechanism 1 are protected by the inlet 22 against weather effects.

The drive surface 16 has a linear or straight-extending region 17. The linear or straight-extending region 17 specifically extends parallel to the guide groove 19.

The linear or straight-extending region 17 is in contact with the drive gear 27 in the closed position of the cover or flap 2 as shown in FIG. 9. Accordingly, as a result of the counterclockwise motion of the drive gear 27, a corresponding linear displacement of the lever arm 15 and therefore the cover or flap 2 into the vehicle outer shell 3 takes place.

The length of the linear or straight-extending region 17 is in particular adapted to the length of the guide groove 19. In particular, the linear or straight-extending region 17 is substantially of the same length or longer than the length of the guide groove 19.

When rotating the drive gear 27 counterclockwise in FIG. 9, the lever arm 15 is translationally shifted inward in relation to the pivot axis 20.

An ending of the translational sliding motion of the lever arm 15 due to the drive gear 27 is shown in FIG. 10.

In FIG. 10, the lever arm 15 and thus the cover or flap 2 have been displaced so far into the outer shell 3 that the pivot/lever arm 15 reaches a second end of the guide groove 19 which is located opposite the first end.

In this position, a further linear or straight-extending sliding of the cover or flap 2 inward is no longer possible.

The drive surface 16 comprises an arc-shaped region 18. The arc-shaped region 18 is arranged immediately adjacent to the linear, i.e., straight-extending, region 17.

The arc-shaped region 18 according to the second exemplary embodiment of the actuating mechanism 1 according to the disclosure as shown in FIG. 9 to FIG. 12 preferably spans an angle of 90°.

In the end position of the linear motion of the cover or flap 2 as shown schematically in FIG. 10, the drive gear 27 comes into contact with the arc-shaped region 18 of the drive surface 16. In other words, the rotational energy of the drive shaft is transferred from the position shown in FIG. 10 to the arc-shaped region 18 of the lever arm 15 via the drive gear 27.

In a further rotation of the drive gear 27 in the counterclockwise direction, the arc-shaped region 18 is traversed by the drive gear 27. This achieves the pivoting motion of the lever arm 15.

In particular, the lever arm 15 is pivoted around the pivot axis 20, as shown, for example, in FIG. 11. In other words, the arc-shaped region 18 is moved through between the pivot axis 20 and the drive gear 27 during the pivoting motion.

In a further motion of the drive gear 27 in the counterclockwise direction, the lever arm 15 is further pivoted until it reaches the open position of the cover or flap 2 shown in FIG. 12.

In the open position of the cover or flap 2 according to FIG. 12, the drive gear 27 can engage with an end stop 21 of the lever arm 15 (cf. FIG. 12). This prevents a further pivoting in the opening direction, so that the open position of the cover or flap 2 can be repeatedly achieved.

The end stop 21 can be formed by a further arc-shaped region 18, which, however, does not serve as a drive surface 16. The for example arc-shaped end stop 21 can be formed in a convex shape, while the arc-shaped region 18 of the drive surface 16 is formed in a concave shape. In other words, the arc-shaped region 18 forms a substantially S-shape with the arc-shaped end stop 21.

By moving the drive gear 27 clockwise, the lever arm 15, and therefore the cover or flap 2, can be transferred from the open position shown in FIG. 12 back into the closed position shown in FIG. 9. This takes place analogously to the opening motion described above; however, a pivoting motion followed by a sliding motion of the lever arm 15 and therefore the cover or flap 2 takes place herein, until the closed position according to FIG. 9 is finally reached.

Preferably, in the second exemplary embodiment of the actuating mechanism 1 according to the disclosure, a spring mechanism is used, which is associated with the movement mechanism 5 or is part of the movement mechanism 5.

As indicated schematically in FIG. 9 to FIG. 12, the (optionally provided) spring mechanism can comprise a spring, in particular configured as a dead-center spring 23, in particular a compression spring.

The spring, which is configured in particular as a compression spring and, as stated above, is in particular a dead-center spring 23, is attached to a lever region of the movement mechanism 5 on the one hand and to a fixed point in relation to the lever region 15 of the movement mechanism 5 on the other hand. The lever region of the movement mechanism 5 is rotatably supported about the axis of rotation 2 as described above, wherein the spring, which is in particular configured as a dead-center spring 23, is arranged in an in particular slightly offset position in relation to the pivot point 20 of the lever region 15 on the lever region 15.

The technical effects achievable with the spring mechanism optionally provided in the second exemplary embodiment according to FIG. 9 to FIG. 12 have already been described in connection with the first exemplary embodiment according to FIG. 1 to FIG. 8, and will not be repeated herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Actuating mechanism
2 Cover/flap
3 Vehicle body/vehicle outer shell
4 Drive shaft
5 Movement mechanism
6 First axis of rotation
7 Second axis of rotation
8 Third axis of rotation
9 Gasket
10 Lever/push-out lever
11 Hinge arm
12 Tappet
13 First region of the gasket
14 Second region of the gasket
15 Lever arm/lever region (second exemplary embodiment)
16 Drive surface (second exemplary embodiment)
17 First (straight-extending) region of drive surface (second exemplary embodiment)
18 Second (arc-shaped) region of the drive surface 16 (second exemplary embodiment)
19 Guide groove (second exemplary embodiment)
20 Pivot axis (second exemplary embodiment)
21 End stop (second exemplary embodiment)
22 Inlet
23 Dead-center/over-dead-center spring
25 Actuating region
26 Spring mechanism
27 Drive gear

What is claimed is:

1. An actuating mechanism (1) for actuating a cover or flap (2) of a vehicle that is manually reversibly movable between a closed position, in which the cover or flap (2) is arranged in flush with a vehicle body, and an open position, in which the cover or flap (2) is arranged at least partially or regionally behind the vehicle body and behind a vehicle outer shell (3), wherein the actuating mechanism (1) comprises a movement mechanism (3) operatively connected to a rear side of the cover or flap (2), in the form of an articulation mechanism or in the form of a guiding mechanism, a cam disk guiding mechanism, which is configured so as to, when transferring the cover or flap (2) from its closed position into its open position, first transfer the cover or flap (2) into an intermediate position in which the cover or flap (2) is located at least partially or regionally behind the vehicle body and behind the vehicle outer shell (3) and then transfer the cover or flap (2) into its open position,
wherein the actuating mechanism (1) further comprises a spring mechanism, which is associated with the movement mechanism (3) or is part of the movement mechanism (3), wherein the spring mechanism is configured so as to do the following:
when transferring the cover or flap (2) from its closed position into its open position, and when transferring the cover or flap (2) from its intermediate position into its open position, apply a first force component to the movement mechanism (3) which supports the transfer of the cover or flap (2) at least into its open position; or
when transferring the cover or flap (2) from its open position into its closed position, and when transferring the cover or flap (2) from its intermediate position into its closed position, apply a first force component to the movement mechanism (3) which supports the transfer of the cover or flap (2) at least into its closed position.

2. The actuating mechanism (1) according to claim 1,
wherein the spring mechanism is configured so as to do the following:
when transferring the cover or flap (2) from its closed position into its open position, and when transferring the cover or flap (2) from its intermediate position into its open position, apply a first force component to the movement mechanism (3) which supports the transfer of the cover or flap (2) into its open position at least until the cover or flap (2) is in a dead-center position between the intermediate position and the open position, wherein the dead-center position of the cover or flap (2) is a bistable position of the cover or flap (2); or
when transferring the cover or flap (2) from its open position into its closed position, and when transferring the cover or flap (2) from its intermediate position into its closed position, apply a first force component to the movement mechanism (3) which supports the transfer of the cover or flap (2) into its closed position at least until the cover or flap (2) is in a dead-center position between the open position and the closed position, wherein the dead-center position of the cover or flap (2) is a bistable position of the cover or flap (2).

3. The actuating mechanism (1) according to claim 2,
wherein the spring mechanism is configured as a dead-center spring lever mechanism, an over-dead-center spring lever mechanism, or is part of a dead-center spring lever mechanism, an over-dead-center spring lever mechanism, wherein the dead-center spring, the over-dead-center spring lever mechanism, is configured so as to do the following:
after overcoming the dead-center position in the direction of the open position of the cover or flap (2), apply a second force component to the movement mechanism (3) which supports the transfer of the cover or flap (2) at least from the dead-center position into the open position; or
after overcoming the dead-center position in the direction of the closed position of the cover or flap (2), apply a second force component to the movement mechanism (3) which supports the transfer of the cover or flap (2) at least from the dead-center position into the closed position.

4. The actuating mechanism (1) according to claim 1, wherein the spring mechanism comprises at least one dead-center spring, which is attached to a lever or to a lever region of the movement mechanism (3) on the one hand and to a point that is fixed with respect to the lever or the lever region of the movement mechanism (3) on the other hand, wherein the lever or lever region of the moving mechanism (3) is rotatably supported about a pivot point.

5. The actuating mechanism (1) according to claim 1 in combination with claim 2, wherein the actuating mechanism (1) is configured such that the cover or flap (2) can be transferred from its open position into its intermediate position by applying manual force to the cover or flap (2).

6. The actuating mechanism (1) according to claim 1,
wherein the cover or flap (2) comprises an actuating region (25) which is arranged on the rear side of the cover or flap (2) and is manually actuatable or graspable, which is configured such that the actuating region (25) is manually actuatable or graspable at least in the open position of the cover or flap (2) such that, in the direction of a biasing force applied by the spring mechanism to the movement mechanism (3) and/or the cover or flap (2), the cover or flap (2) is manually transferable from its open position into a dead-center position of the cover or flap (2) and/or into the intermediate position of the cover or flap (2).

7. The actuating mechanism (1) according to claim 1,
wherein the movement mechanism (3), which is operatively connected to the rear side of the cover or flap (2), is configured so as to, when transferring the cover or flap (2) from its closed position into its open position, first transfer the cover or flap (2) into the intermediate position in a linear movement, a pure linear movement, and then transfer the cover or flap (2) into the open position in an at least substantially and purely rotational movement.

8. The actuating mechanism (1) according to claim 1, and according to claim 7, wherein the movement mechanism (3) which is operatively connected to the rear side of the cover or flap (2) comprises a guiding mechanism, a link guiding mechanism and/or a cam disk mechanism, which is configured so as to, when transferring the cover or flap (2) from its closed position into its intermediate position, realize a corresponding linear movement of the cover or flap (2) relative to the vehicle body and relative to the vehicle outer shell (3), and which is further configured so as to, when transferring the cover or flap (2) from its intermediate position into its open position, realize an at least substantially and purely rotational movement of the cover or flap (2) relative to the vehicle body and relative to the vehicle outer shell (3).

9. The actuating mechanism (1) according to claim 1,
wherein the movement mechanism (3) which is operatively connected to the rear side of the cover or flap (2), is configured so as to, when transferring the cover or flap (2) from its closed position into its open position, first transfer the cover or flap (2) into the intermediate position in a rotational and translational movement, superposed according to the superposition principle, and then transfer the cover or flap (2) into the open position in an at least substantially and purely rotational movement, wherein the movement mechanism (3) is configured so as to do the following:
(a) proceeding from the closed position of the cover or flap (2), first move the cover or flap (2) into the intermediate position in the rotational and translational movement, superposed according to the superposition principle, in which the cover (2) is in a position in which the cover (2) is pivoted relative to the closed position of the cover (2) about a first axis of rotation (6) and is at least partially or regionally offset in comparison to the closed position backwards towards the interior of the vehicle; and
(b) subsequently, proceeding from the intermediate position of the cover or flap (2), pivot the cover or flap (2) in the at least substantially and purely rotational movement about a second axis of rotation (7) into the open position, in which the cover or flap (2) is arranged at least partially or regionally behind the vehicle body and behind the vehicle outer shell (3),
wherein the first axis of rotation (6) about which the cover or flap (2) is movable into the intermediate position in a rotational and translational movement, superposed according to the superposition principle, matches the second axis of rotation (7) about which the cover or flap (2) is pivotable into the open position proceeding from its closed position.

10. The actuating mechanism (1) according to claim 9,
wherein the cover or flap (2) is associated with a seal (9) that partially or regionally surrounds the cover or flap (2) and is configured so as to seal a region between the cover or flap (2) and the vehicle body, the vehicle outer shell (3), at least in the closed position of the cover or flap (2), wherein the movement mechanism (3) is configured so as to, when transferring the cover or flap (2) proceeding from the closed position of the cover or flap (2), move the cover or flap (2) into the intermediate position in a rotational and translational movement, superposed according to the superposition principle, in such a way that the seal (9) partially or regionally surrounding the cover or flap (2) moves faster in a first region (16) of the seal (9) relative to the cover or flap (2) or relative to the vehicle body, the vehicle outer shell (3), than in a second region (17) of the seal (9) that lies opposite the first region (16) of the seal (9).

11. The actuating mechanism (1) according to claim 9,
wherein the movement mechanism (3) comprises a lever (10) rotatably supported about the first axis of rotation (6), a push-out lever, and a hinge arm (11), wherein a first end region of the hinge arm (11) is fixedly connected or connectable to the rear side of the cover (2), and wherein an opposite second end region of the hinge arm (11) is hingedly connected to the lever (10), wherein, at least over a defined or definable angular range, the hinge arm (11) is pivotable via its second end region about a third axis of rotation (8) relative to the lever (10), wherein the third axis of rotation (8) extends parallel to the first axis of rotation (6) about which the lever (10) is rotatably supported.

12. The actuating mechanism (1) according to claim 11,
wherein the lever (10) comprises a tappet (12), which is configured so as to also move and rotate the hinge arm (11) when the lever (10) is moved, wherein the tappet (12) is configured so as to, proceeding from a resting position of the lever (10) in which the cover or flap (2) is in its closed position, enter into contact with the hinge arm (11) only after rotation of the lever (10) about a defined or definable angular range about the first axis of rotation (6) of the lever (10), wherein at that time and upon a further rotation of the lever (10), the lever (10) is additionally pivoted with the hinge arm (11) about the first axis of rotation (6) of the lever (10), wherein, after rotation of the lever (10) about the defined or definable angular range about the first axis of rotation (6) of the lever (10), the cover is in its intermediate position.

13. The actuating mechanism (1) according to claim 12,
wherein a spring mechanism (26) and/or a mechanical blockage is associated with the movement mechanism (3), which is configured so as to hold the hinge arm (11) and the lever (10) together when the tappet (12) enters or has entered into contact with the hinge arm (11).

14. The actuating mechanism (1) according to claim 1,
wherein the actuating mechanism (1) further comprises an electromotive drive, and wherein the movement mechanism (3) which is operatively connected to the rear side of the cover or flap (2) is further operatively connected to the electromotive drive and to a drive shaft thereof.

15. An assembly comprising:
an inlet, a sensor inlet;
a cover or flap (2) for covering the inlet, wherein the cover or flap (2) is reversibly movable and pivotable between a closed position in which the cover or flap (2) is arranged flush with a vehicle outer shell (3) and an open position in which the cover or flap (2) is arranged behind the outer shell; and
an actuating mechanism (1) according to claim 1,
wherein the actuating mechanism (1) comprises an electromotive drive with a drive shaft, wherein the electromotive drive is arranged behind the inlet.

16. The actuating mechanism (1) according to claim 1, wherein the cover or flap (2) is arranged preferably strake-flush with the vehicle body.

17. The actuating mechanism (1) according to claim 1, wherein the cover or flap (2) into its open position in a purely rotational movement.

18. The actuating mechanism (1) according to claim 4, wherein the at least one dead-center spring is an over dead-center spring (23) attached to the lever or lever region in a slightly offset position relative to the pivot point of the lever or lever region, wherein the at least one dead-center spring is configured as a compression spring.

19. The actuating mechanism (1) according to claim 5, wherein the spring mechanism is configured to automatically transfer the cover or flap (2) into its dead-center position and, after overcoming the dead-center position, transfer the cover or flap (2) into its closed position preferably automatically by applying manual force to the cover or flap (2).

20. The actuating mechanism (1) according to claim 15, wherein the assembly is a LIDAR system assembly or a charging, service, or fueling assembly.
